(19) United States
(12) Patent Application Publication
(10) Pub. No.: US 2003/0084980 A1
(43) Pub. Date: May 8, 2003

(54) Lightweight gypsum wallboard and method of making same

(76) Inventors: James F. Seufert, North Tonawanda, NY (US); Brian D. Conner, Cheektowaga, NY (US); Carol A. Urban, Eden, NY (US); Richard P. Weir, Kenmore, NY (US)

Correspondence Address: Howrey Simon Arnold & White, LLP, 750 Bering Drive, Houston, TX, 77057-2198, US

(21) Appl. No.: 09/992,322

(22) Filed: Nov. 6, 2001

(51) Int. Cl. C04B 11/00

(52) U.S. Cl. 156/39; 106/772; 423/171; 423/535

(57) ABSTRACT

A method of preparation and use of lightweight, high-strength gypsum wallboard, as well as a core composition suitable for use therein, are disclosed. The core composition includes a slurry of calcium sulfate hemihydrate (stucco), water, acid-modified starch, and a starch cross-linking agent, having a pH of about 9 to about 11. The composition and method provide a wallboard having a lower density than conventional wallboard, and with equivalent or better strength characteristics than conventional wallboard.

### FIELD OF THE INVENTION

The invention generally relates to the production of lightweight gypsum-containing products and, more specifically, the invention relates to a method and composition for producing lightweight gypsum wallboard and related products.

### BACKGROUND OF THE INVENTION

A common method of constructing walls and barriers includes the use of inorganic wallboard panels or sheets, such as gypsum wallboard, often referred to simply as “wallboard” or “drywall.” Wallboard can be formulated for interior, exterior, and wet applications. The use of wallboard, as opposed to conventional boards made from wet plaster methods, is desirable because the installation of wallboard is ordinarily less costly and less cumbersome than installation of conventional plaster walls.

Walls and ceilings made with gypsum wallboard panels typically are constructed by securing, e.g., with nails or screws, the wallboard panels to structural members, such as vertically- and horizontally-oriented pieces of steel or wood often referred to as “studs.”

Generally, wallboard is produced by enclosing a core composition including an aqueous slurry of calcined gypsum and other materials (“core composition”) between two large sheets of board cover paper (also called surface paper). Various types of cover paper are used, depending on the particular application. After the core composition has set (i.e., reacted with water present in the aqueous slurry) and dried, the formed sheet is cut into standard sizes. Methods for the production of gypsum wallboard generally are described, for example, by T. Michelsen, “Building Materials (Survey),” Encyclopedia of Chemical Technology, (1992 4th ed.), vol. 21, pp. 621-24, TP9.E685, the disclosure of which is hereby incorporated herein by reference.

Gypsum wallboard is manufactured utilizing commercial processes that are capable of operation under continuous, high-speed conditions. A conventional process for manufacturing the core composition of gypsum wallboard initially includes the premixing of dry ingredients in a high-speed mixing apparatus. The dry ingredients can include calcium sulfate hemihydrate, an accelerator, and a binder (e.g., starch). The dry ingredients are mixed together with a “wet” (aqueous) portion of the core composition in a pin mixer apparatus. The wet portion can include a first component, commonly referred to as a “paper pulp solution,” that includes a mixture of water, paper pulp, and, optionally, one or more fluidity-increasing agents, and a set retarder. The paper pulp solution provides a major portion of the water that forms the gypsum slurry of the core composition. A second wet component can include a mixture of foam and other conventional additives, if desired. Together, the aforementioned dry and wet portions comprise an aqueous gypsum slurry that forms a core composition.

A major ingredient of the core composition is calcium sulfate hemihydrate, commonly referred to as “calcined gypsum,” “stucco,” or “plaster of Paris.” Stucco has a number of desirable physical properties including, but not limited to, its fire resistance, thermal and hydrometric dimensional stability, compressive strength, and neutral pH. Typically, stucco is prepared by drying, grinding, and calcining natural gypsum rock (i.e., calcium sulfate dihydrate). Typical impurities found in the natural gypsum rock include impurities such as clay, quartz, dirt, sand, sodium chloride, calcium chloride, and dolomitic limestone. The drying step of stucco manufacture includes passing crude gypsum rock through a rotary kiln to remove any free moisture present in the rock from rain or snow, for example. The dried rock then is passed through a roller mill (or impact mill types of pulverizers), wherein the rock is ground or comminuted to a desired fineness. The degree of comminution is determined by the ultimate use. The dried, fine-ground gypsum can be referred to as “land plaster” regardless of its intended use. The land plaster is used as feed to calcination processes for conversion to stucco.

The calcination (or dehydration) step in the manufacture of stucco is performed by heating the land plaster, and generally can be described by the following chemical equation which shows that heating calcium sulfate dihydrate yields calcium sulfate hemihydrate (stucco) and water vapor:

CaSO₄.2H₂O+heat→CaSO₄.½H₂O+1½H₂O.

This calcination process step is performed in a “calciner,” of which there are several types known by those of skill in the art.

Uncalcined calcium sulfate (i.e., land plaster) is the “stable” form of gypsum. However, calcined gypsum, or stucco, has the desirable property of being chemically reactive with water, and will “set” rather quickly when the two are mixed together. This setting reaction is actually a reversal of the above-described chemical reaction performed during the calcination step. The setting reaction proceeds according to the following chemical equation which shows that the calcium sulfate hemihydrate is rehydrated to its dihydrate state:

CaSO₄.½H₂O+1½H₂O→CaSO₄.2H₂O+heat.

The actual time required to complete the setting reaction generally depends upon the type of calciner and the type of gypsum rock that are used to produce the gypsum, and can be controlled within certain limits by the use of additives such as retarders, set accelerators, and/or stabilizers, for example. Generally, the rehydration time period can be in a range of about two minutes to about eight hours depending on the amount and quality of retarders, set accelerators, and/or stabilizers present.

After the aqueous gypsum slurry is prepared, the slurry and other desired ingredients are combined to form a core composition that is continuously deposited to form a wallboard core between two continuously-supplied moving sheets of board cover paper. The two cover sheets generally comprise a pre-folded face paper and a backing paper. As the core composition is deposited onto the face paper, the backing paper is brought down atop the deposited core composition and bonded to the pre-folded edges of the face paper. The whole assembly then is sized for thickness utilizing a roller bar or forming plate. The deposited core composition is then allowed to set between the two cover sheets, thereby forming a gypsum wallboard. The continuously-produced board is cut into panels of a desired length and then passed through a drying kiln where excess water is removed to form a strong, dry, and rigid building material.

The cover sheets used in the process typically are multi-ply paper manufactured from re-pulped newspapers and/or other grades of recycled papers. The face paper has an unsized inner ply which contacts the core composition such that gypsum crystals can grow up to (or into) the inner ply—this, along with the starch, is the principal form of bonding between the core composition and the cover sheet. The middle plies are sized and an outer ply is more heavily sized and treated to control absorption of paints and sealers. The backing paper is also a similarly constructed multi-ply sheet. Both cover sheets must have sufficient permeability to allow for water vapor to pass through them during the downstream board drying step(s).

Standardized sheets (or panels) of wallboard typically are cut and trimmed to dimensions of about four feet (about 1.2 meters) wide and about 8 feet to about 16 feet (about 2.4 meters to about 4.9 meters) in length (ASTM-C36). Sheets typically are available in thicknesses varying in a range of about ¼ inch to about one inch (about 0.635 centimeters (cm) to about 2.54 cm) in about ⅛ inch (about 0.3175 cm) increments.

The time at which the board may be cut, or in other words, the speed of the conveyor and the consequent rate of production of the gypsum board, is generally controlled by the setting time of the calcined gypsum slurry. Thus, conventional adjuvants to the calcined gypsum slurry in the mixer generally include set time control agents, particularly accelerators. These and other additives, such as pregenerated foam to control final density of the board, paper cover sheet bond promoting agents, fibrous reinforcements, consistency reducers and the like typically constitute less than 5%, and usually less than 2%, of the weight of the finished board core.

Numerous compositions and methods of production of wallboards have been disclosed.

U.S. Pat. No. 5,641,584 (issued Jun. 24, 1997) offers mixtures of cement, a rheology modifying agent, and a lightweight aggregate material for use as an insulating material. The materials may further contain fibrous materials.

U.S. Pat. No. 5,922,447 (issued Jul. 13, 1999) suggests gypsum boards containing gypsum, perlite, and starch. The starch is used to act as a binder for binding the gypsum to the perlite.

U.S. Pat. No. 5,888,322 (issued Mar. 30, 1999) offers methods for preparing gypsum wallboard containing polymeric oxyalkylate viscosity modifiers. The use of various polymers and copolymers are suggested.

U.S. Pat. No. 5,305,577 (issued Apr. 26, 1994) suggests fire resistant cores containing gypsum dihydrate, paper fiber, and performance boosters (inorganic fiber, clay, vermiculite, or binder polymer). Structures containing the core have at least a 20 minute ASTM E-152 fire test rating.

U.S. Pat. Nos. 4,916,004 and 5,221,386 offer methods for the continuous production of wallboards containing cement cores strengthened by a mesh of reinforcing fibers.

U.S. Pat. No. 5,342,566 (issued Aug. 30, 1994) proposes methods and apparatus for the production of gypsum boards. The method included mixing fibers, absorbent, and water to form a mixture, mixing the wetted fibers with dry calcined gypsum, forming the resulting mixture into a matt, and compressing the matt to produce a gypsum board.

U.S. Pat. No. 3,952,830 (issued Apr. 27, 1976) describes acoustical panels containing expanded volcanic glass, mineral fibers, cellulosic fiber, and binder and sizing agents. The fibers act to hold the perlite particles in position during the manufacturing process, and creates an interconnected network of voids.

U.S. Pat. No. 4,019,920 (issued Apr. 26, 1977) describes mixtures of gypsum and starch which function as an accelerator for the setting reaction of calcined gypsum and water.

U.S. Pat. No. 4,350,533 (issued Sep. 21, 1982) offers mixtures of high alumina cement, gypsum, lime, and water for use in preparing high early strength cement. Early stages of hydration produces ettringite.

U.S. Pat. No. 5,879,446 (issued Mar. 9, 1999) suggests core compositions and methods for the production of gypsum wallboards. The core compositions contain a slurry of calcium sulfate hemihydrate, water, and calcium aluminum lignosulfonate and/or aluminum lignosulfonate. The compositions can be supplemented with paper fibers, corn starch, or potash.

U.S. Pat. No. 5,277,712 (issued Jan. 11, 1994) offers a drywall panel joint compound containing fine plaster, alkyl cellulose, perlite, and a set time retarding agent. The joint compound exhibits flexural strength of at least 50 pounds/lineal inch, minimum shrinkage, and substantially no visible cracking under hot and dry atmospheric conditions.

U.S. Pat. No. 4,174,230 (issued Nov. 13, 1979) suggests the preparation of gypsum compositions comprising at least one binder selected from the group consisting of a water-soluble organic polymer, a water-dispersible organic polymer, a water-soluble inorganic compound, a water-dispersion medium colloid-forming inorganic compound, a water-hardenable compound and a mixture thereof. The composition is used in lightweight gypsum moldings which exhibit great mechanical strength.

Standardized sheets of wallboard typically have a density in a range of about 1,600 pounds (lbs.) to about 1,800 lbs. per thousand square feet (lbs/MSF) (about 7,800 kilograms (kg) to about 8,300 kg per thousand square meters (m²)) of about one-half inch (1.27 cm) board. Heavy or high-density gypsum wallboards are more costly and difficult to manufacture, transport, store, and manually install at job sites, compared to lighter or low-density boards. It is possible to formulate wallboard having reduced densities through the inclusion of lightweight fillers and foams, for example. Often, however, where wallboard is formulated to have a density less than about 1,600 lbs/MSF (about 7,800 kg per 1,000 m²) of about one-half inch (1.27 cm) board, the resulting low strength makes the board unacceptable for commercial sale. Because high-density or heavy gypsum wallboard generally is not desirable, various attempts have been made to reduce board weight and density without sacrificing board strength. However, while lighter and less dense wallboard products can be produced, many of the wallboard products may be of a quality ill-suited for commercial use.

One type of gypsum wallboard panel product failure occurs when a fastener head, such as a nail head, is pulled through the gypsum wallboard panel. The strength measure of a gypsum wallboard panel for this type of failure is known as nail pull resistance. Standardized tests to measure nail pull resistance (e.g. ASTM C 473-00), typically measure the ability of a gypsum wallboard panel to resist pull-through of a standard size nail head through the product.

Another measure of gypsum wallboard panel strength is its compressive strength, which is its ability to resist compressive forces. Compressive strength also is an indirect measure of other strength properties such as transverse load strengths, sag resistance, 90° pull force resistance, and core tensile strength, for example.

In view of the foregoing, it would be desirable to produce high-strength gypsum wallboard having weights and densities generally equal to or slightly less than those produced by conventional methods. Reduced weight and density boards, however, should meet industry standards and have strengths similar to, or greater than, conventional wallboard of higher density. Such wallboard also should be able to be manufactured using high-speed manufacturing apparatus and not suffer from other negative side-effects. For example, such high-strength wallboard should be able to set and dry within a commercially reasonable period of time.

### SUMMARY OF THE INVENTION

It is an object of the invention to overcome one or more of the problems described above.

Thus, one aspect of the invention is a composition for use in the manufacture of gypsum construction materials including calcium sulfate hemihydrate, acid-modified starch, a starch cross-linking agent, and sufficient water to form a slurry, having a pH of about 9 to about 11.

Another aspect of the invention is a method of making a composition for use in gypsum board manufacturing processes. The method generally includes the steps of: forming a slurry including water, acid-modified starch, a starch cross-linking agent, and calcium sulfate hemihydrate, having a pH of about 9 to about 11; and mixing the slurry.

Yet another aspect of the invention is a wallboard panel which includes a first cover sheet, a second cover sheet, and a core disposed between the cover sheets, wherein the core includes calcium sulfate dihydrate, and cross-linked, acid-modified starch.

Still another aspect of the invention is a method of producing gypsum wallboard. The method generally includes the step of forming a slurry containing water, calcium sulfate hemihydrate, acid-modified starch, and a starch cross-linking agent, having a pH of about 9 to about 11. The method also includes the steps of mixing the slurry, and depositing the slurry on a cover sheet.

Further aspects and advantages of the invention may become apparent to those skilled in the art from a review of the following detailed description, taken in conjunction with the appended claims.

### DETAILED DESCRIPTION OF THE INVENTION

Generally, the invention is directed to a composition for use in the manufacture of gypsum construction materials, such as gypsum wallboard. The term “core composition” will be used to refer to the wet slurry containing calcium sulfate hemihydrate that is useful in producing a wallboard article, and to the term “wallboard core” will be used to refer to the hardened (i.e., set) material containing calcium sulfate dihydrate. The core composition includes calcium sulfate hemihydrate, acid-modified starch, a starch cross-linking agent, and sufficient water to form a slurry. The invention also is directed to gypsum wallboard panels, methods of making the core composition, and methods of making gypsum wallboard panels.

The core composition of the invention provides improvements in properties of a wallboard core and wallboard article, such as increased strength per unit density and improved bonding between the paper cover sheet and the wallboard core. Core compositions and wallboard cores made according to the invention can be made lighter in weight (i.e., lower density) and with the same or better strength characteristics as typical, heavier (i.e., more dense) wallboard.

The ingredients of a preferred core composition of the invention will now be described in more detail. One dry ingredient present in a core composition of the invention is calcium sulfate hemihydrate, or stucco (CaSO₄.½H₂O). Preferably, the β-hemihydrate form of calcium sulfate hemihydrate is used in the invention, however, either the α- or β-form may be used. The core composition includes at least about 40 wt. % calcium sulfate hemihydrate, preferably up to about 60 wt. %, more preferably at least about 35 wt. % and up to about 55 wt. %, and even more preferably at least about 40 wt. % and up to about 55 wt. %, for example about 48 wt. % calcium sulfate hemihydrate, based on the total weight of the core composition. The calcium sulfate hemihydrate can be produced by a dry calcination method, such as kettle, Calcidyne, Holo-flite, rotary kiln, Imp Mill, or Claudius Peters calcination. The calcium sulfate hemihydrate can also be produced by wet calcination methods.

The core composition also includes a starch, which functions as a binder within the wallboard core and at the interface of the wallboard core and a cover sheet. Different types of starches may be used in the wallboard core. Typically, wallboard binders are manufactured from starches made from corn, wheat, or milo. Non-modified starches such as pearl starch may be used in the inventive compositions and methods. Cationic starches work well on a pound per pound basis as compared to other starches, but are currently relatively expensive. Acid-modified starches are attractive due to their current low cost relative to other commercially available starches. Acid-modified starch is typically available as a dry powder, and can be added with other dry ingredients, in a liquid pulp solution, or in a separate liquid feed. Without intending to be bound by any particular theory, it is believed that the advantages of the invention are achieved by lowering the gelatinization temperature of the starch, so that the starch can migrate faster and deposit more starch at the cover paper/core interface, and also by cross-linking the starch to solidify it and prevent it from completely migrating out of the core. Any acid-modified starch suitable in typical gypsum construction materials (such as wallboards, mortars, and joint compounds) can be used in a core composition according to the invention. Acid-modified corn starch is a widely available material. A suitable starch for the invention is an acid-modified (also called “acid hydrolyzed”) starch sold as Wallboard Binder Starch, CAS #65996-63-6, by A. E. Staley Manufacturing Co., of Decatur, Ill.

The amount of starch used in a core composition and wallboard core according to the invention is generally greater than the amount of starch used in typical gypsum construction materials, and particularly greater than the amount used in conventional wallboard.

The core composition preferably includes at least about 0.5 wt. % acid-modified starch, preferably up to about 1.5 wt. %, more preferably at least about 0.6 wt. % and up to about 1 wt. %, for example about 0.8 wt. % acid-modified starch, based on the total weight of the core composition. When the core composition sets, the relative amount of starch will increase slightly due to loss of water on drying.

Any chemical that cross-links a starch added to the core composition can be used in the invention. Various starch cross-linking agents are known in the art. Suitable starch cross-linking agents include sodium metaborate, potassium tripolyphosphate, borax, sodium metaborate hydrate, boric acid, magnesium oxide, type N hydrated lime, and combinations thereof. Magnesium oxide and type N hydrated lime are preferred, particularly type N hydrated lime.

Type N dolomitic hydrated lime is primarily a mixture of about 48 wt. % calcium oxide, about 31 wt. % magnesium oxide, and chemically combined water. Since type N dolomitic hydrates are derived from dolomitic quicklime (which, in turn, is derived from limestone containing about 35 wt. % to about 46 wt. % magnesium carbonate) hydrated under atmospheric pressure, water is combined only with the calcium oxide portion of the lime. Type N hydrated lime made from high calcium quicklime (derived from limestone having up to about 5 wt. % magnesium carbonate) and magnesium quicklime (derived from limestone having about 5 wt. % to about 35 wt. % magnesium carbonate) are also available. A suitable type N dolomitic hydrated lime is sold under the name GRAND PRIZE finish lime by Graymont Dolime (OH), Inc. (Genoa, Ohio). When type N hydrolyzed lime is used, it is preferably added as a dry ingredient with the stucco.

A starch cross-linking agent is added in an amount sufficient to cross-link the starch to create a substantially solid starch (e.g., thicker than a typical “thick boiling” starch) before the starch has the time to completely migrate out of the core composition to the cover paper/core interface. Generally, a starch cross-linking agent is present in the core composition in a range of at least about 10 wt. % and up to about 30 wt. %, preferably at least about 12 wt. % and up to about 25 wt. %, based on the weight of the acid-modified starch.

Without intending to be bound by any particular theory, it is believed that raising the pH of the core composition lowers the gelatinization temperature of the starch and increases its mobility. For example, a typical acid-modified corn starch used as a wallboard binder has a gelatinization temperature of about 160 to about 170° F., for example about 162° F. In cooked form, the typical starch is thin boiling (i.e., thin and syrup-like when cooking is completed) but it turns to a soft gel when cooled. In contrast, it has been found that an acid-modified corn starch mixed with type N hydrated lime has a gelatinization temperature of about 140° F. to about 150° F., for example about 142° F. In cooked form, this acid-modified starch is solidified (i.e., is thicker than a typical “thick boiling” starch), and syneresis is evident upon cooling of the cooked starch. In this example, it is believed that the calcium hydroxide component of the type N hydrated lime contributes to the affect upon gelatinization temperature, and the magnesium oxide component of the type N hydrated lime contributes to the cross-linking of the starch. Various other compounds can be used to raise the pH of the core composition, but calcium hydroxide (present as type N hydrated lime) is preferred.

When using type N hydrated lime as a starch cross-linking agent, the pH of the core composition can be made too high. For example, as the pH is raised above about 11.2, the wet bond between a cover sheet and the core composition is reduced to the point where high-speed board manufacture is nearly impossible at a pH of about 12. Preferably, the pH of the core composition is about 10.8 or less. A minimum pH of the core composition of about 9 is preferred, and a pH in the range of about 10 to about 10.4, for example about 10.2, is more preferred.

Various additives (such as inorganic acids) can be used to reduce the pH of the core composition, but alum (aluminum sulfate) is preferred. When type N hydrated lime is used, aluminum sulfate is present preferably in an amount about equal by weight to said type N hydrated lime. Alum is available as a solid or in an aqueous liquid solution, such as by General Chemical Corporation of Parsipany, N.J. When added to the core composition as a solid, it preferably is fed with the stucco and other dry ingredients; when added as a liquid, it preferably is metered to the mixer as an independent feed.

Various other ingredients, such as paper fibers and foaming agents, can be used in the core composition to provide additional strength and flexibility and to further reduce the density of the wallboard, while maintaining strength. In similar fashion, other additives can be used to facilitate the manufacturing process, such as dispersants (also known as water reducing agents) and gypsum set accelerators. These optional ingredients will be discussed below.

Cellulosic fibers, such as paper fibers preferably are added to the core composition, most preferably with other additives in an aqueous pulp slurry or solution. Preferably, a paper pulp solution provides a major portion of the water that forms the slurry of the core composition. The water supplied to the core composition should include sufficient water for the setting reaction of the gypsum, plus an additional amount sufficient to decrease the consistency of the slurry during the manufacturing process. The cellulosic fibers preferably are paper fibers, more preferably and conveniently derived from ground wallboard paper cover sheet offstock.

The cellulosic fibers in the pulp solution serve to enhance the flexibility and overall strength of the gypsum wallboard. Gypsum wallboard made without fibers is typically very brittle and more susceptible to breakage during handling. The cellulosic fibers aid in evenness of drying during manufacture, and enhance the ability of the final wallboard article to accept and hold nails during installation.

Generally, cellulosic fibers are present in a core composition and wallboard core of the invention in greater amounts than in typical gypsum wallboard construction. Thus, when paper fiber is used it is preferably present in an amount of at least about 0.5 wt. % and up to about 0.75 wt. %, based on the weight of the calcium sulfate hemihydrate. Put another way, paper fiber preferably is present in an amount of about 0.4 wt. % to about 0.6 wt. %, based on the weight of a wallboard core.

Wet ingredients used to make the core composition preferably include a foaming agent (i.e., soap). Foam introduces air voids into the core through the use of a foaming agent that contains very little solid material, but is resilient enough to resist substantial breakdown in the mixing operation. In this manner, the density of the core can be reduced in a controlled manner. A foaming agent can be supplied in either liquid or flake (powdered) form, and can be produced from various soaps, including those known in the art. A suitable foaming agent for the invention is a sulfated, ethoxylated, primary, linear alcohol mixture which is described by the chemical formula CH₃(CH₂)ₓCH₂(OCH₂CH₂)_{y}OSO₃⁻M⁺, wherein x normally lies in the range of 6 to 8, y ranges between 1.5 and 2.5 (with 2.2 being preferred), and M is selected from the group consisting of sodium and ammonium, such as CEDEPAL FA-406, sold by the Stepan Company of Northfield, Ill. See also U.S. Pat. No 4,156,615 (May 29, 1979), the disclosure of which is incorporated herein by reference.

Preferably, a foaming agent is present in the core composition in an amount of at least about 0.01 wt. % and up to about 0.1 wt. %, more preferably at least about 0.03 wt. % and up to about 0.08 wt. %, based on the weight of the calcium sulfate hemihydrate or the weight of the wallboard core. The amount of foaming agent added can vary depending on the source (and, thus, quality) of the calcium sulfate hemihydrate (e.g., source of the land plaster) used to produce the core composition.

“Water-reducing” additives may be included in the core composition to improve its fluidity while allowing the use of reduced levels of water. Reduction in water usage brings reduced costs in the form of reduced water and energy demands, as less water will have to be removed during the drying step(s). Reduction of water usage also provides environmental benefits.

Various commercially-available dispersants (also known as fluidity-enhancing and/or water-reducing agents) are known in the art for various applications. However, lignosulfonate materials, used as dispersants in other wallboard applications, are to be avoided in the methods and compositions of the invention. Fluidity-enhancing and/or water-reducing agents supplied in liquid form can be either incorporated in the pulp solution or added directly to the mixing operation. The use of condensation products of naphthalene sulfonic acid and formaldehyde is preferred. A suitable water-reducing agent useful in the invention is a sodium salt of sulfonated naphthalenesulfonate, sold under the trade name DILOFLO GW, by Geo Chemicals, Inc. (Harrison, N.J.). The use of higher molecular weight anionic condensation products such as melamine formaldehyde modified with sulfite alkylaryl sulfonates is also known. See also U.S. Pat. No. 4,184,887, the disclosure of which is hereby incorporated herein by reference.

Water-reducing agents are described in “The Gypsum Industry and Flue Gas Desulftuization (FGD) Gypsum Utilization: A Utility Guide,” New York State Electric & Gas Corp. and ORTECH, pp. 3-38 (1994), the disclosure of which is hereby incorporated herein by reference.

Preferably, a dispersant, such as a naphthalene sulfonate, is present in an amount of at least about 0.15 wt. % and up to about 0.4 wt. %, based on the weight of the calcium sulfate hemihydrate or the wallboard core.

An accelerator can be used to accelerate the set of calcium sulfate hemihydrate to calcium sulfate dihydrate and thus produce the wallboard core from the core composition. Examples of suitable accelerators, some of which also are available liquid form, include, but are not limited to, ball milled accelerators (“BMA”) and metallic salts that provide cations, such as aluminum sulfate, potassium sulfate (sulfate of potash), calcium sulfate, ferrous sulfate, and ferric chloride supplied, for example, by the J. T. Baker Chemical Company of Philadelphia, N.J. The preferred accelerator is a BMA made by combining very finely ground gypsum (land plaster) with an acid-modified starch in a ball mill, in a ratio of approximately 1:1. The fine gypsum crystals act as seed crystals to spur crystal growth, and the starch acts as a flow agent. Potassium sulfate is also preferred. The amount of accelerator added can vary depending on the source (and, thus, quality) of the calcium sulfate hemihydrate (e.g., source of the land plaster) used to produce the core composition.

A set retarder optionally may be added with the paper pulp solution and can be used in conjunction with the aforementioned accelerator in order to tailor the set time of the core composition. Set retarding agents are known in the art, and are made from organic material such as hog's hair, hooves, and the like, or from chemical polymers which provide similar functionality. Set retarding agents are typically used in the invention at very low concentrations such as, for example, about 0.01 wt. %, based on the weight of the calcium sulfate hemihydrate or the wallboard core, or about 0.005 wt. %, based on the weight of the core composition.

In some embodiments, lightweight aggregates (e.g., expanded perlite or vermiculite) also can be included.

A pulp solution can be prepared, for example, by blending or mixing cellulosic fiber, dispersant, set retarder, and starch with water in a blending apparatus. Alternatively, a concentrated pulp solution using only a small volume of water can be produced. In this case, the remainder of the core mix water requirement is made up with a separate water source. Typically, about 75 weight parts water are used per 100 weight parts stucco. Preferably, high shear mixing “pulps” the material, forming a homogenous solution or slurry. The pulp solution can be transferred to a holding vessel, from which it can be continuously added to the core composition mix.

Gypsum wallboard can be adapted for wet and exterior applications, in addition to use in constructing interior walls and ceilings. In the production of production of exterior sheathing and moisture-resistant board cores, various materials can be incorporated into the core composition to impart increased absorption resistance to the board. Useful materials include silicone and other water repellents, waxes, and asphalt emulsions. These materials are typically supplied as water emulsions to facilitate ease of incorporation into the board core. These materials can be added directly into the mixing apparatus or incorporated into the pulp solution prior to addition to the mixing apparatus.

The invention is not limited to any order or manner of mixing the ingredients described above.

Approximate ranges and specific examples (in brackets) of amounts of ingredients for a core composition of the prior art and one embodiment of a core composition according to the invention are shown in Table I below, wherein the amount of each ingredient is specified as pounds per thousand square feet of ½ inch (1.27 cm) wallboard (lb/MSF). A panel of ½ inch (1.27 cm) wallboard has an overall thickness of ½-inch (1.27 cm) provided by a wallboard core sandwiched between two cover sheets, each cover sheet having a thickness of about 13 thousandths of an inch to about 17 thousandths of an inch (about 0.33 mm to about 0.44 mm), for example about 16 thousandths of an inch (about 0.4 mm).

TABLE I

| Ingredient | Prior Art | Embodiment of Invention |
|---|---|---|
| stucco | 1250 to 1475 [1433.4] | 1150 to 1375 [1334.1] |
| water | 958 to 1130 [1098.6] | 896 to 1072 [1039.7] |
| starch | 5.5 to 13.0 [10.0] | 15.5 to 23.0 [20.0] |
| paper fiber | 0.0 to 8.0 [2.9] | 7.5 to 8.5 [8.0] |
| type N hydrated lime | — [0.0] | 2.5 to 5.0 [2.5] |
| aluminum sulfate | — [0.0] | 2.5 to 5.0 [2.5] |
| dispersant | 1.0 to 5.5 [2.0] | 2.5 to 6.5 [3.0] |
| set accelerator | 2.0 to 4.5 [2.5] | 2.0 to 4.5 [2.5] |
| dextrose | 1.0 to 2.5 [1.4] | 1.0 to 2.5 [1.4] |
| foaming agent | 0.4 to 1.1 [0.6] | 0.4 to 1.1 [0.6] |
| potassium sulfate | 0.25 to 2.5 [0.5] | 0.25 to 2.5 [0.5] |
| set retarder | 0.10 to 0.20 [0.15] | 0.10 to 0.20 [0.15] |

A preferred process for manufacturing the core composition and wallboard of the invention initially includes the premixing of dry ingredients in a mixing apparatus. The dry ingredients preferably include calcium sulfate hemihydrate (stucco), an optional accelerator, and starch. The dry ingredients are preferably mixed together with one or more “wet” (aqueous) portions of the core composition in a pin mixer apparatus. However, the invention is not limited to the order and manner of mixing the ingredients described above.

The core composition thus produced is deposited between paper cover sheets to form a sandwich. The core composition is allowed to cure or set, whereby calcium sulfate hemihydrate is converted to calcium sulfate dihydrate. As described above, the starch migrates from the core composition to the core/cover sheet interface, and cross-links. The product then preferably is dried by exposing the product to heat, in order to remove excess water not consumed in the reaction forming the calcium sulfate dihydrate.

The setting reaction produces gypsum crystals, which are interwoven to contribute strength to the dried wallboard core. The crosslinked starch preferably bonds the gypsum wallboard core to the cover sheets, providing an enhanced bond. The cross-linked starch also preferably contributes to enhanced bond between gypsum crystals, paper fibers, and other ingredients throughout the wallboard core. This bonding increases the strength of a wallboard article and enhances other properties of a wallboard article, such as resistance to peel and more uniform score and snap characteristics.

In order to demonstrate the advantageous results of the invention, comparative testing has been performed.

The following examples are included to demonstrate preferred embodiments of the invention. It should be appreciated by those of skill in the art that the techniques disclosed in the examples which follow represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### EXAMPLES

### Example 1

Samples of ½-inch (1.27 cm) wallboard of the prior art and according to an embodiment of the invention were produced from core composition prepared in accordance with the specific, examples described in Table I above. The boards had the constituents and properties identified in Table II below, wherein the amount of each ingredient is specified as pounds per thousand square feet (lb/MSF) of ½ inch (1.27 cm) wallboard having cover sheets of about 11 thousandths of an inch (about 0.4 mm).

TABLE II

| Ingredient | Prior Art | Embodiment of Invention |
|---|---|---|
| gypsum | 1674.9 | 1558.8 |
| starch | 10.0 | 20.0 |
| paper fiber | 2.9 | 8.0 |
| type N hydrated lime | 0.0 | 2.5 |
| aluminum sulfate | 0.0 | 2.5 |
| dispersant | 2.0 | 3.0 |
| set accelerator | 2.5 | 2.5 |
| dextrose | 1.4 | 1.4 |
| foaming agent | 0.6 | 0.6 |
| potassium sulfate | 0.5 | 0.5 |
| set retarder | 0.15 | 0.15 |
| cover sheets | 85.0 | 85.0 |
| TOTAL WEIGHT | 1780 | 1685 |

The wallboard produced according to the invention was nearly 100 pounds (45.4 kg) lighter per thousand square feet (per 93 m²) than the wallboard produced according to the prior art. The core composition used to produce wallboard according to the invention had a pH of about 10.

### Example 2

Additional boards were produced on a mass scale according to the formulations provided in Example I above, except that: (1) about 12.5 lb/MSF and about 22.5 lb/MSF of acid-modified starch were used in the boards of the prior art and the invention, respectively; and (2) about 2.8 lb/MSF and about 8.3 lb/MSF of paper fiber were used in the boards of the prior art and the invention, respectively. About 160 prior art boards and 90 boards according to the invention were produced and tested for various strength characteristics, as described below. On the day that the boards according to the prior art formulation were produced, the average land plaster purity was about 81.1 wt. % calcium sulfate hemihydrate, the balance (according to typical conditions) including impurities such as clay, quartz, dirt, sand, sodium chloride, calcium chloride, and dolomitic limestone; dolomitic limestone was a significant portion of the impurities. On the day that the boards according to the invention were produced, the average land plaster purity was about 80.1 wt. % calcium sulfate hemihydrate, the balance (according to typical conditions) including impurities such as clay, quartz, dirt, sand, sodium chloride, calcium chloride, and dolomitic limestone; dolomitic limestone was a significant portion of the impurities. The core composition used to produce boards according to the invention had a pH in the range of about 9.8 to about 10.2.

Comparative testing was performed on the wallboards produced as described above for various characteristics of strength and quality, including tests on “nail pull resistance,” “end peel,” “score and snap,” “shear width,” “shear split,” and “humidified bond.”

Nail pull resistance testing measures the ability of a gypsum wallboard panel to resist pull-through of a standard size nail head through the product. Nail pull tests were conducted on the samples according to ASTM C 473-00, Method A, the disclosure of which is hereby incorporated herein by reference.

End peel tests were performed to quantify the degree of paper-to-core bond failure at the ends of the wallboard. To perform the test, the face paper at the board end is grasped with a thumb and index finger, the thumbnail is inserted into the board core at the end (to take a “bite” of core), and the face paper is peeled back in the machine direction (i.e., perpendicular to the width) until it tears through the topliner paper ply. The procedure is repeated at approximately 12 inches, 24 inches, and 36 inches across the width of the board, on both the front and back sides of the board, and the maximum value is reported.

Common wallboard installation practice involves scoring one side of a gypsum wallboard, snapping the core at the score line, and back-snapping the unscored paper. Normally, the back-snapping is done by merely pulling the board toward the scored side to separate the board into two pieces. Board quality relative to this test is evaluated by how smooth, straight, and free of protrusions from the core that the snapped edge is and whether the wallboard core integrity is compromised. The test is performed on board samples that are “hot” at the takeoff of the production line. Because flexing a wallboard can produce knobby scores by causing microscopic stress cracking in the core, to simulate normal handling condition a second board sample is pre-flexed by lifting a board at opposing ends high enough that the center of the board is suspended above the working surface. To perform the test, the board is scored on the back, across the full width (perpendicular to the paperbound edges, using a square), 36 inches in from a mill cut end. The sample is then snapped at the score line, and then the 36-inch section is folded back until it is at a 90 degree angle from the remainder of the board. Finally, the board is unfolded so that it is flat again, and the 36-inch section is pulled up (back-snapped, toward the back of the board) to separate the board into two pieces. The end of the 36-inch board section is examined to measure core protrusions, i.e., the maximum distance that any portion of the gypsum core extends out beyond the score line.

The shear width and shear split tests are used to gauge wallboard core integrity, quality of drying conditions, and degree of bond between the wallboard core and surface papers. To perform the tests, a full-width piece of wallboard (e.g., 48 inches) is manually broken into two piece, and the broken edges (generally wedge-shaped) of the two broken ends are evaluated for shear width and shear split. Shear width (in inches) is the greatest linear distance from the end of one surface paper to the end of the opposing surface paper across the broken edge of wallboard, measured in a direction parallel to the major plane of a wallboard piece and perpendicular to the broken end of a wallboard piece. Shear split (in inches) is a measure of separation between the wallboard core and surface papers at the broken ends, and is the average of the greatest linear distance (front and back surface papers) of separation, measured in the same direction as shear width. Each test is performed on a board still hot from the take-off of production and again after a board has been conditioned overnight (at least 12 hours) at warehouse conditions.

The humidified bond test measures the degree of bond (and bond failure) between a wallboard core and surface papers of a humidified sample (48 square inches) of wallboard. Two specimens are tested: one having been in a humidifier for two hours, and one having been in a humidifier for 20 hours. Each specimen shows a minimum moisture reading of “50 plus” with a Data Tech moisture meter upon completion of each respective humidification period (or a reading of between 28 and 34 after two hours of humidification and 50 maximum scale reading after 20 hours of humidification, as measured by a Sensortech Model PMT-110 meter). After humidification, a sample is scored across the width of the board on one side (i.e., one surface paper), the wallboard core is broken at the score line, and then the surface paper is pulled from the wallboard core on each end of the broken sample. The procedure is repeated by scoring the opposite surface paper in a distant portion of the sample and similarly pulling the surface paper from the wallboard core. The bond failure is evaluated by inspection.

Results of the foregoing tests are tabulated below in Table III. With the exception of the nail pull test, the lower the reported number, the better is the result and, hence, the better the wallboard quality.

TABLE III

| Test | Prior Art | | Embodiment of Invention | |
|---|---|---|---|---|
| Nail Pull Resistance | 89.8 | lb (40.7 kg-force) | 88.0 | lb (39.9 kg-force) |
| End Peel | 0.33 | inch (0.84 cm) | 0.19 | inch (0.48 cm) |
| Score & Snap | | | | |
| hot at take-off - as is | 1/16 | inch (0.16 cm) | 1/16 | inch (0.16 cm) |
| hot and flexed | 1/4 | inch (0.64 cm) | 1/8 | inch (0.32 cm) |
| Shear Width | | | | |
| hot at take-off | 3.79 | inches (9.63 cm) | 3.32 | inches (8.43 cm) |
| overnight | 4.63 | inches (11.76 cm) | 3.29 | inches (8.36 cm) |
| conditioned | | | | |
| Shear Split | | | | |
| hot at take-off | 0.84 | inch (2.1 cm) | 0.36 | inch (0.91 cm) |
| overnight | 1.63 | inch (4.14 cm) | 0.79 | inch (2.01 cm) |
| conditioned | | | | |
| Humidified Bond | 79% | peel | 18% | peel |

The results of Examples 1 and 2 demonstrate that a core composition according to the invention produces lightweight gypsum articles having strength and quality characteristics comparable to, and in some cases better than, heavier gypsum articles of the prior art. Other properties of wallboard articles produced according to the invention may also be benefited by use of the inventive methods and compositions, including transverse load strengths, sag resistance, 90° pull force resistance, and core tensile strength. In addition, the inventive compositions and methods may advantageously provide these strengths over substantial periods of time and at humidified conditions.

All of the compositions and/or methods and/or processes and/or apparatus disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and/or apparatus and/or processes and in the steps or in the sequence of steps of the methods and/or processes described herein without departing from the concept, spirit and scope of the invention. All such similar substitutes and modifications apparent to those skilled in the art are deemed to be within the spirit, scope and concept of the invention.

What is claimed is:

1. A composition for use in the manufacture of gypsum construction materials, the composition comprising:
at least about 40 wt. % calcium sulfate hemihydrate, based on the total weight of the composition;
starch;
a starch cross-linking agent; and
sufficient water to form a slurry; wherein the pH of the composition is about 9 to about 11.

2. The composition of claim 1, wherein the composition comprises about 40 wt. % calcium sulfate hemihydrate to about 60 wt. % calcium sulfate hemihydrate, based on the total weight of the composition.

3. The composition of claim 1, wherein the composition comprises about 40 wt. % calcium sulfate hemihydrate to about 55 wt. % calcium sulfate hemihydrate, based on the total weight of the composition.

4. The composition of claim 1, wherein the starch is a cationic starch.

5. The composition of claim 1, wherein the starch is an acid-modified starch.

6. The composition of claim 1, wherein the starch is an acid-modified corn starch.

7. The composition of claim 6, wherein the acid-modified corn starch is present in an amount of about 0.6 wt. % to about 1 wt. %, based on the weight of the calcium sulfate hemihydrate.

8. The composition of claim 1, wherein the starch cross-linking agent is present in an amount of about 12 wt. % to about 25 wt. %, based on the weight of the starch.

9. The composition of claim 1, wherein the starch cross-linking agent is selected from the group consisting of magnesium oxide, sodium metaborate, potassium tripolyphosphate, borax, sodium metaborate hydrate, boric acid, type N hydrated lime, and combinations thereof.

10. The composition of claim 1, wherein the starch cross-linking agent is type N hydrated lime, present in an amount of about 12 wt. % to about 25 wt. %, based on the weight of the starch.

11. The composition of claim 1, wherein the starch cross-linking agent is type N hydrated lime, present in an amount of about 15 wt. % to about 25 wt. %, based on the weight of the starch.

12. The composition of claim 1, wherein the composition has a pH of about 10.8 or less.

13. The composition of claim 10, further comprising aluminum sulfate.

14. The composition of claim 13, wherein the pH of the composition is about 9 to about 11.

15. The composition of claim 13, wherein the starch cross-linking agent is present in the form of type N hydrated lime and the aluminum sulfate is present in an amount about equal by weight to the type N hydrated lime.

16. The composition of claim 1, further comprising cellulosic fiber.

17. The composition of claim 1, further comprising paper fiber.

18. The composition of claim 17, wherein the paper fiber is present in an amount of about 0.5 wt. % to about 0.75 wt. %, based on the weight of the calcium sulfate hemihydrate.

19. The composition of claim 1, further comprising a foaming agent.

20. The composition of claim 19, wherein the foaming agent is present in an amount of about 0.03 wt. % to about 0.08 wt. %, based on the weight of the calcium sulfate hemihydrate.

21. The composition of claim 1, further comprising a dispersant.

22. The composition of claim 1, further comprising naphthalene sulfonate.

23. The composition of claim 22, wherein the naphthalene sulfonate is present in an amount of about 0.15 wt. % to about 0.4 wt. %, based on the weight of the calcium sulfate hemihydrate.

24. A wallboard panel comprising:
a first cover sheet;
a second cover sheet; and
a core disposed between the first cover sheet and the second cover sheet, the core comprising calcium sulfate dihydrate and starch.

25. The wallboard panel of claim 24, wherein the panel has a substantially uniform thickness of about ½ inch, and the density of the panel is about 1,500 lb/MSF to about 1,700 lb/MSF.

26. The wallboard panel of claim 24, wherein the core comprises at least about 90 wt. % calcium sulfate dihydrate, based on the weight of the core.

27. The wallboard panel of claim 24, wherein the starch is a cationic starch.

28. The wallboard panel of claim 24, wherein the starch is an acid-modified starch.

29. The wallboard panel of claim 24, wherein the starch is a cross-linked acid-modified starch.

30. The wallboard panel of claim 24, wherein the starch is a cross-linked acid-modified corn starch.

31. The wallboard panel of claim 30, wherein the cross-linked acid-modified corn starch is present in an amount of about 1 wt. % to about 2 wt. %, based on the weight of the core.

32. The wallboard panel of claim 24, wherein the core further comprises aluminum sulfate.

33. The wallboard panel of claim 32, wherein the aluminum sulfate is present in an amount of about 0.15 wt. % to about 0.35 wt. %, based on the weight of the core.

34. The wallboard panel of claim 24, wherein the core further comprises cellulosic fiber.

35. The wallboard panel of claim 24, wherein the core further comprises paper fiber.

36. The wallboard panel of claim 35, wherein the paper fiber is present in an amount of about 0.4 wt. % to about 0.6 wt. %, based on the weight of the core.

37. The wallboard panel of claim 24, wherein the core further comprises a foaming agent.

38. The wallboard panel of claim 37, wherein the foaming agent is present in an amount of about 0.03 wt. % to about 0.8 wt. %, based on the weight of the core.

39. The wallboard panel of claim 24, wherein the core further comprises a dispersant.

40. The wallboard panel of claim 24, wherein the core further comprises naphthalene sulfonate.

41. The wallboard panel of claim 40, wherein the naphthalene sulfonate is present in an amount of about 0.15 wt. % to about 0.4 wt. %, based on the weight of the core.

42. The wallboard panel of claim 24, wherein the core comprises:
at least about 90 wt. % calcium sulfate dihydrate;
about 1.0 wt. % to about 2 wt. % cross-linked, acid-modified starch;
about 0.15 wt. % to about 0.35 wt. % aluminum sulfate;
about 0.4 wt. % to about 0.6 wt. % paper fiber;
about 0.15 wt. % to about 0.4 wt. % naphthalene sulfonate; and
about 0.03 wt. % to about 0.8 wt. % of a foaming agent, all based on the weight of the core.

43. A method of producing a gypsum wallboard, the method comprising:
forming a slurry comprising water, calcium sulfate hemihydrate, starch, and a starch cross-linking agent;
mixing the slurry; and
depositing the slurry on a cover sheet.

44. The method of claim 43, wherein the starch is a cationic starch.

45. The method of claim 43, wherein the starch is an acid-modified starch.

46. The method of claim 43, wherein the starch is a cross-linked acid-modified starch.

47. The method of claim 43, wherein the starch is a cross-linked acid-modified corn starch.
